(19) United States
(12) Patent Application Publication
(10) Pub. No.: US 2017/0324855 A1
(43) Pub. Date: Nov. 9, 2017

(54) COMMUNICATION TERMINAL, AND INCOMING CALL ASSISTANCE PROGRAM, METHOD, AND DEVICE

(71) Applicant: FUJITSU LIMITED, Kawasaki-shi (JP)

(72) Inventor: Yasuo Matsushima, Kawasaki (JP)

(73) Assignee: FUJITSU LIMITED, Kawasaki-shi (JP)

(21) Appl. No.: 15/659,173

(22) Filed: Jul. 25, 2017

Related U.S. Application Data
(63) Continuation of application No. PCT/JP2016/053393, filed on Feb. 4, 2016.

(30) Foreign Application Priority Data
Feb. 4, 2015 (JP) 2015-020565

(51) Int. Cl. H04M 1/65; H04M 3/51; H04M 1/26

(52) U.S. Cl. CPC H04M 1/6505; H04M 1/26; H04M 3/51

(57) ABSTRACT

A communication terminal, capable of making a voice call to a call destination designated in accordance with a call instruction, includes a memory and a processor that reads and executes instructions stored by the memory. The processor, when the call instruction is detected, performs voice call processing on the call destination and performs data transmission processing that transmits identifying information to an address associated with the call destination.

### CROSS-REFERENCE TO RELATED APPLICATION

This application is a continuation application of International Application No. PCT/JP/2016/053393, filed Feb. 4. 2016, the disclosure of which is incorporated herein by reference in its entirely.

### FIELD

The embodiments discussed herein are related to a communication terminal, a recording medium storing an incoming call assistance program, an incoming call assistance program method, and an incoming call assistance program device.

### BACKGROUND

A system that causes coordination between an interactive voice response (IVR) device and a private branch exchange exists as a system for configuring a call center having plural telephones that plural operators respectively respond to. When a telephone call is made to a call center employing such a system, a user responds to the IVR by pressing a numbered button or the like on the telephone in accordance with voice guidance by the IVR, and sends a dual-tone multi-frequency (DTMF) signal corresponding to selected content. In such systems, an operator is selected in accordance with stipulations by the user based on selected content indicated by the DTMF signal, and an incoming call from the user is connected to a telephone line of the selected operator.

Further, there is also technology that employs electronic mail, a web system, or the like as a method for contacting the user. For example, technology has been proposed that saves callback request information when corresponding with a customer in order to callback and correspond with the customer at a later time, wherein at least information identifying the customer and information identifying the operator who handled the earlier correspondence with the customer is incorporated into the callback request information. In such technology, when calling back from a call center-side based on callback request information of the earlier call prepared in a predictive call task, the callback is connected to the operator who handled the earlier correspondence with the customer, identified based on the callback request information.

Further, technology has been proposed in which information exchange between a user of a voice terminal and a user of a data terminal is performed. In such technology, the user of the voice terminal publishes information request data (voice data and keywords) received from the voice terminal, to a web server. The user of the data terminal watches the information request data and in response, returns providable-information data to the web server. Further, the providable-information data is converted into a synthesized voice and reported to the user of the voice terminal.

### RELATED DOCUMENTS

### Related Patent Documents

Japanese Patent Application Laid-Open (JP-A) No. 2005-005928 JP-A No. 2004-304612

### SUMMARY

According to an aspect of the embodiments, a communication terminal is provided that is capable of making a voice call to a call destination designated in accordance with a call instruction, the communication terminal comprising: a memory, and a processor coupled to the memory and the processor configured to: in response to the call instruction being detected, perform voice call processing with respect to the call destination and perform data transmission processing that transmits identifying information to an address associated with the call destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining exchange between a user and a call center employing an IVR.

FIG. 2 is a functional block diagram illustrating a schematic configuration of an incoming call assistance system.

FIG. 3 is a conceptual diagram illustrating an example of IVR definitions.

FIG. 4 is a diagram illustrating an example of an IVR selection option database (DB).

FIG. 5 is a diagram illustrating an example of an incoming call information DB.

FIG. 6 is a diagram illustrating an example of a call center designation screen.

FIG. 7 is a diagram illustrating an example of an input screen.

FIG. 8 is a diagram illustrating an example of an input screen after accepting input.

FIG. 9 is a block diagram illustrating a schematic configuration of a computer that functions as a communication terminal.

FIG. 10 is a block diagram illustrating a schematic configuration of a computer that functions as an incoming call assistance device.

FIG. 11 is a block diagram illustrating a schematic configuration of a computer that functions as an operator terminal.

FIG. 12 is a flowchart illustrating an example of communication terminal-side processing.

FIG. 13 is a flowchart illustrating an example of incoming call assistance processing.

FIG. 14 is a flowchart illustrating an example of response-time processing.

FIG. 15 is a flowchart illustrating an example of unresponded handling processing.

FIG. 16 is a flowchart illustrating an example of flag setting command processing.

FIG. 17 is a sequence chart illustrating a flow of processing of an incoming call assistance system.

FIG. 18 is a sequence chart illustrating a flow of processing of an incoming call assistance system.

### DESCRIPTION OF EMBODIMENTS

Incoming calls in a call center when there is a shortage of lines is first described before describing an exemplary embodiment in detail.

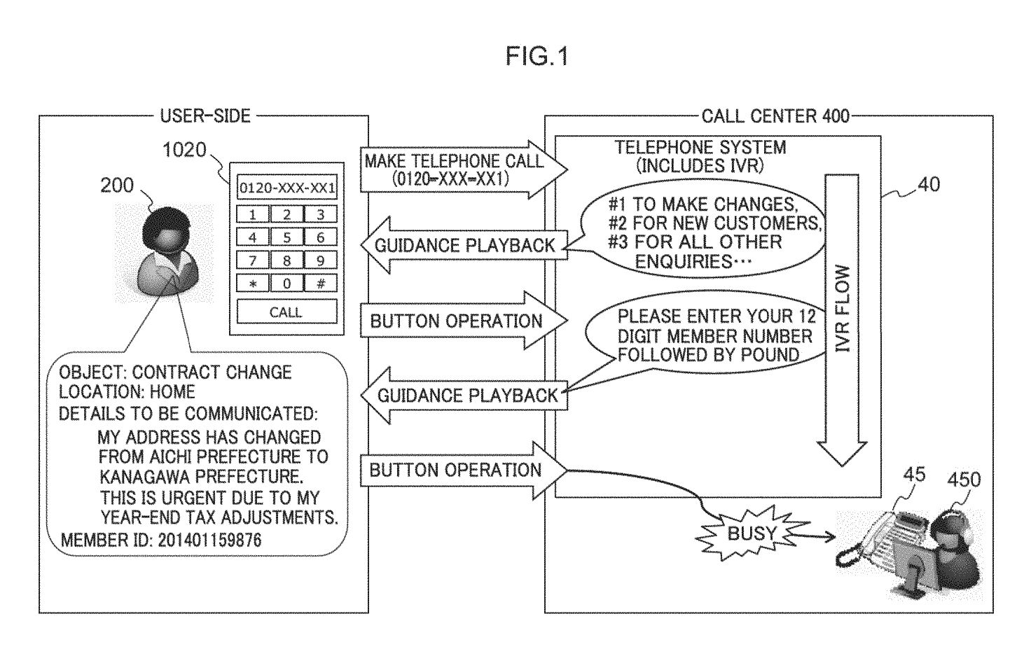

As illustrated in FIG. 1, when a user 200, for example, makes a telephone call to a call center 400 from a communication terminal 1020 such as a smartphone, the incoming call is received by a telephone system 40 in the call center 400. The telephone system 40 includes an interactive voice response device (IVR). The IVR executes an IVR flow in accordance with predetermined IVR definitions. For example, the IVR first plays back initial voice guidance. The user 200 listens to the voice guidance and responds to the IVR by operating the numbered button of the item that matches the object of making the telephone call. The IVR plays back the next piece of voice guidance in order to Obtain thither needed information, and the user 200 responds to this by operating a numbered button. In the IVR, when the needed information has been acquired, the telephone system 40 connects the incoming call from the user 200 to a line of a telephone 45 of an operator 450 responsible for handling the object of the user 200.

However, here, in cases in which the line of the telephone 45 corresponding to the responsible operator 450 is busy, connection to the line may be unsuccessful and the telephone call from the user 200 may be missed owing to a line shortage or the like. Further, although the user 200 is placed on hold until the line is connected in some cases, the telephone call may be cancelled at the user 200 side and the call abandoned when the line has not connected despite waiting some time.

No incoming call history from the user 200 is left at the call center 400 side in such cases, and the operator is unable to follow up on the incoming call from the user 200, since the fact that there was a missed or abandon call is not ascertained. Accordingly another telephone call needs to be made to the call center 400 from the user 200 in order to fulfill the object of the user 200. In this event, there is a need to respond to the IVR once more and the burden on the user 200 is large.

Further, in the response to the IVR itself, there is the annoyance of having to listen to long guidance, since the items are not selectable unless the guidance is listened to. Further, after having listened to the voice guidance and ascertained the selection option, there is a high possibility of selection mistakes, since the selection options are selected by button operations. Further, there is a high possibility of input mistakes when, for example, inputting a number having many digits, such as a member number, by button operations. In some cases, responses to the IVR need to be re-done from the start when there have been selection mistakes or input mistakes. Even if such responses to the IVR that place burden on the user 200 are overcome, a line of the telephone 45 of the operator 450 is not connected to in some cases since the lines are busy as described above, and this may cause a drop in customer satisfaction.

Furthermore, in cases in which an incoming call from the user 200 has connected to a line of the telephone 45 of the operator 450, the operator 450 needs to listen to the issue of the user 200 by conversation with the user 200 in some cases. This may cause a drop in productivity when the conversation is prolonged.

The present exemplary embodiment therefore provides an incoming call assistance system capable of ascertaining even incoming calls in the call center 400 that were not successfully responded to by the operator 450 owing to a shortage of lines or the like. In addition, burden on the user 200 caused by responding to the IVR is reduced, and assistance is given when the operator 450 listens to the user 200.

Detailed description of the present exemplary embodiment follows, with reference to the drawings.

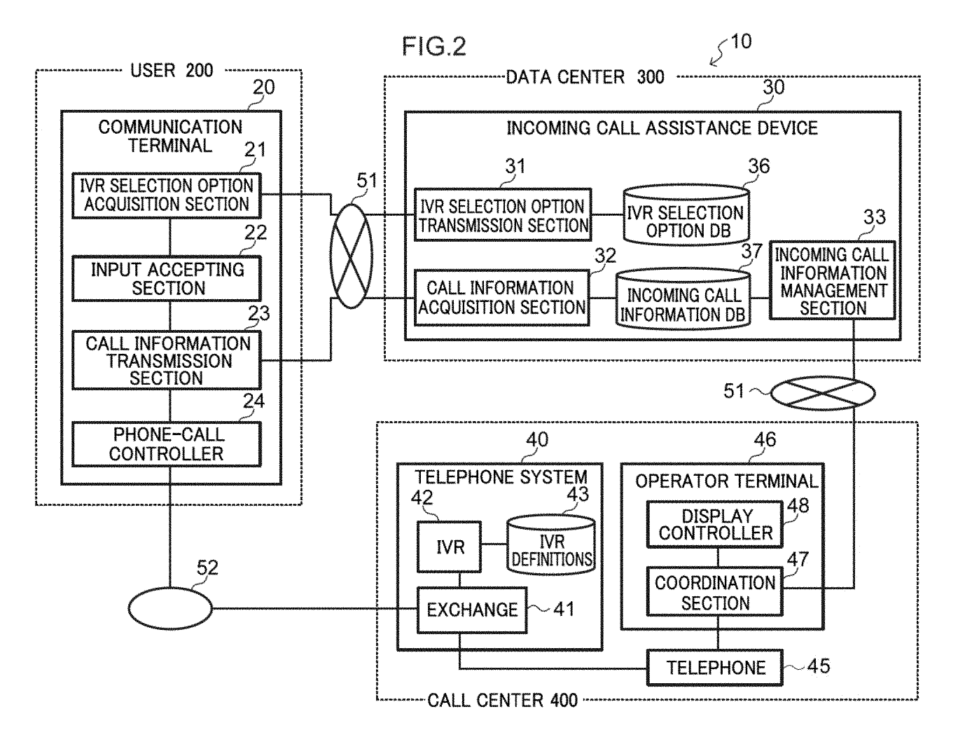

As illustrated in FIG. 2, an incoming call assistance system 10 according to the present exemplary embodiment includes a communication terminal 20 employed by the user 200, an incoming call assistance device 30 disposed in a data center 300, the telephone system 40 disposed in the call center 400, the telephone 45, and an operator terminal 46. The communication terminal 20 and the operator terminal 46 are each connected to the incoming call assistance device 30 via an interact network 51. Further, the communication terminal 20 and the telephone system 40 are connected via a public network 52.

First, configuration in the call center 400 is described.

The telephone system 40 connects incoming calls from the communication terminal 20 to a line of a telephone 45 from out of plural telephones 45 (only one unit is illustrated in FIG. 2) in the call center 400 using coordination between an exchange 41 and an IVR 42. The IVR 42 sends voice guidance to the communication terminal 20 in accordance with IVR definitions 43 in which processing flows are defined for interactively responding to the incoming call from the communication terminal 20. Further, the IVR 42 receives and processes response signals from the communication terminal 20.

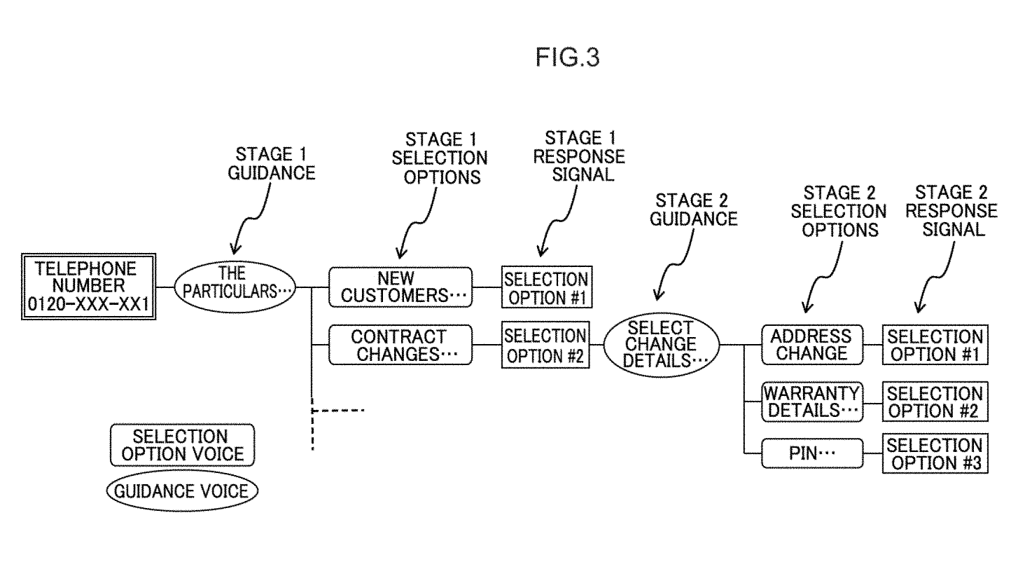

FIG. 3 illustrates a conceptual example of the IVR definitions 43. In the IVR definitions 43 of FIG. 3, the voice guidance initially sent when there has been an incoming call in the call center 400 is defined as “stage 1 guidance”. For example, the stage 1 guidance can be set to content that describes a first item for the user 200 to respond to. Then, guidance for the selection options of the items indicated in the stage 1 guidance that the user 200 selects from are defined as “stage 1 selection options”. Response signals are sent from the communication terminal 20 when the user 200 has selected a selection option, and the response signals (for example, a dual-tone multi-frequency (DTMF) signal) are respectively associated with each of the stage 1 selection options as “stage 1 response signals”. “Stage 2 guidance” is defined continuing on from the response signal of stage 1 when the IVR 42 seeks a further response from the user 200 in accordance with the response signal of stage 1. Thereafter, “stage 2 selection options” and “stage 2 response signals” are similarly defined.

The IVR 42 selects the responsible operator 450 line to connect to based on the issue of the user 200 indicated by the response signals received from the communication terminal 20 and the predetermined operator 450 responsible for each issue. The exchange 41 connects the incoming call from the communication terminal 20 to the line of the telephone 45 corresponding to the operator 450 selected by the IVR 42.

The operator terminal 46 is, for example, an information processing device such as a personal computer (PC) provided with input devices, such as a keyboard and mouse, and a display device. Operator terminals 46 are provided to correspond to each telephone 45. Each operator terminal 46 includes a coordination section 47 and a display controller 48 as functional sections.

The coordination section 47 manages coordination between the telephone 45 and the operator terminal 46, and between the operator terminal 46 and the incoming call assistance device 30.

More specifically when the coordination section 47 detects that the operator 450 has responded to the incoming call from the communication terminal 20 connected to the line of the corresponding telephone 45 (that the operator 450 has picked up the telephone), the coordination section 47 transmits a response report to the incoming call assistance device 30. The response report includes the following information: the telephone number of the call center 400 in which the operator terminal 46 is disposed, the telephone number of the communication terminal 20, and the response date and time. The coordination section 47 can, for example, acquire the caller's telephone number reported to a caller's number report service as the telephone number of the communication terminal 20.

Further, the coordination section 47 transmits a list request to the incoming call assistance device 30 in cases in which the operator 450 has operated the input devices of the operator terminal 46 to request a list of unresponded incoming call information. The list request includes the telephone number of the call center 400 in which the operator terminal 46 is disposed. Further, if needed, a designation of a date and time or an IVR selection result (described in detail later) or the like may be included in designation information for designating incoming call information to be incorporated into the list.

Further, when the operator 450 has operated the input devices of the operator terminal 46 to command that the incoming call be set as responded to, the coordination section 47 transmits a response-flag-setting command to the incoming call assistance device 30. The response-flag-setting command includes information for identifying incoming call information (described in detail later) such as the telephone number of the call center 400 in which the operator terminal 46 is disposed, the caller's telephone number, and the incoming call date and time.

Further, when the coordination section 47 receives a list of incoming call information corresponding to a response report or unresponded incoming call information from the incoming call assistance device 30, the coordination section 47 passes the received incoming call information or list to the display controller 48.

The display controller 48 displays the incoming call information or list passed from the coordination section 47 on the display device of the operator terminal 46. Further, the display controller 48 performs display control of various display screens such as a menu screen related to the incoming call assistance system 10.

Next, the incoming call assistance device 30 is described. As illustrated in FIG. 2, the incoming call assistance device 30 includes an IVR selection option transmission section 31, a call information acquisition section 32, and an incoming call information management section 33 as functional sections. The IVR selection option transmission section 31 is an example of a transmission section of the present invention. Further, the call information acquisition section 32 is an example of an acquisition section of the present invention. The incoming call information management section 33 is an example of a management section of the present invention.

Based on the telephone number of the call center 400 designated from an IVR selection option acquisition section 21 of the communication terminal 20, described later, the IVR selection option transmission section 31 transmits, to the communication terminal 20, IVR selection option information for generating response signals corresponding to the IVR 42 of the call center 400. The IVR selection option transmission section 31 acquires IVR selection option information of the call center 400 from an IVR selection option database (DB) 36 in which IVR selection option information extracted from the IVR definitions 43 of each call center 400 is registered.

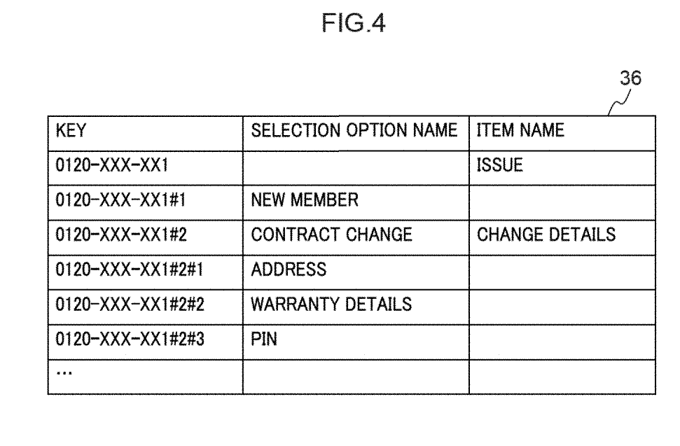

FIG. 4 illustrates an example of the IVR selection option DB 36. The IVR selection option DB 36 of FIG. 4 is an example of a database registered with IVR selection option information extracted from the IVR definitions 43 illustrated in FIG. 3. Each row of the IVR selection option DB 36 is a single piece of IVR selection option information, and each piece of IVR selection option information includes the following information: “key” serving as an identifier for the item and selection option and “selection option name” and “item name” that are titles of the selection option and item indicated by the key. Here, “key” represents a concatenation of the telephone number of the call center 400 and the response signal corresponding to each selection option of each stage of the IVR definitions 43. Further, “selection option name” is a keyword extracted from the selection options of each stage of the IVR definitions 43 and “item name” is a keyword extracted from the guidance of each stage of the IVR definitions 43. Note that the IVR selection option information is not limited to the data structure illustrated in FIG. 4. It is sufficient that the information needed for generation of the response signal to the IVR 42 is included in the communication terminal 20.

More specifically, the IVR selection option transmission section 31 acquires, from the IVR selection option DB 36, IVR selection option information that has a key including the telephone number of the call center 400 designated by the communication terminal 20, and transmits the acquired IVR selection option information to the communication terminal 20.

The call information acquisition section 32 acquires call information transmitted from a call information transmission section 23 of the communication terminal 20, described later. As is described in more detail later, when a call is made from the communication terminal 20 to the call center 400 via the public network 52, the call information is information related to the call and includes the telephone number of the call center 400, the telephone number of the communication terminal 20, the IVR selection result, and other additional information.

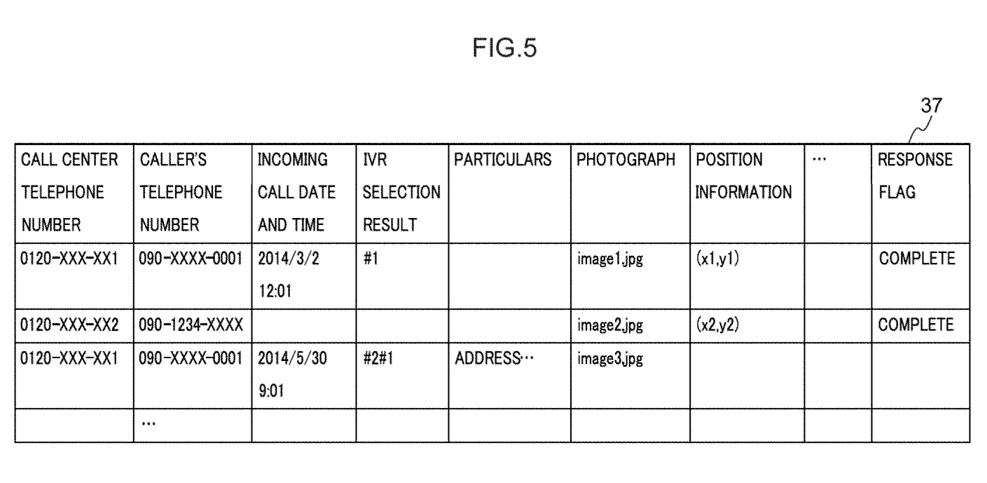

The call information acquisition section 32 registers the acquired call information in an incoming call information DB 37. Note that the call information from the communication terminal 20 is incoming call information from the viewpoint of the call center 400 side, and the call information registered in the incoming call information DB 37 is therefore referred to as incoming call information. More specifically, the call information acquisition section 32, for example, registers, in the incoming call information DB 37, the acquired call information as incoming call information, as illustrated in FIG. 5. In the example of FIG. 5, each row of the incoming call information DB 37 is one item of incoming call information, and each item of incoming call information includes the following information: “call center telephone number”, “caller's telephone number”, “incoming call date and time”, “IVR selection result”, “particulars”, “photograph”, “position information”, and “response flag”. “Caller's telephone number” is the telephone number of the communication terminal 20. “Incoming call date and time” is the date and time at which the call information was acquired by the call information acquisition section 32.

“Particulars”, “photograph”, and “position information” are each additional information included in the call information. “IVR selection result” and the additional information are both described in detail later. “Response flag” is information indicating whether or not an operator 450 has responded to the incoming call from the user 200 indicated by the incoming call information. For example, the response flags of incoming call information that has been responded to by an operator 450 are set to “complete” and the response flags of incoming call information unresponded to by an operator 450 are not set (are blank).

When the incoming call information management section 33 receives the response report from the coordination section 47 of the operator terminal 46, the incoming call information management section 33 searches the incoming call information DB 37 for the corresponding incoming call information using the telephone number of the call center 400, the telephone number of the communication terminal 20, and the response date and time included in the response report, which serve as a key. The incoming call information management section 33 then provides the found incoming call information to the coordination section 47. For example, the incoming call information management section 33 searches for incoming call information in which the “call center telephone number” and the “caller's telephone number” match the telephone number of the call center 400 and the telephone number of the communication terminal 20 included in the response report, and in which the incoming call date and time is the closest to the response date and time included in the response report. The incoming call information management section 33 sets the response flag of the incoming call information provided to the coordination section 47 to “complete” in accordance with the response report.

Further, when the incoming call information management section 33 receives a list request from the coordination section 47 of an operator terminal 46, the incoming call information of the incoming call information DB 37 in which the “response flag” is not set, namely incoming call information unresponded to by an operator 450, is extracted and provided to the coordination section 47 as a list. The incoming call information incorporated into the list is incoming call information found using the information included in the list request received from the operator terminal 46 as a query.

Further, when the incoming call information management section 33 has received a response-flag-setting command from the coordination section 47 of the operator terminal 46, the incoming call information management section 33 sets the response flag of the incoming call information identified by the information included in the response-flag-setting command, from out of the incoming call information included in the incoming call information DB 37, to “complete”.

Note that the incoming call assistance device 30 is not limited to being disposed in the data center 300, and may be disposed in the call center 400. It is sufficient for the incoming call assistance device 30 to function in an environment where data can be exchanged between the communication terminal 20 and each operator terminal 46.

Next, the communication terminal 20 is described. The communication terminal 20 is, for example, a terminal having voice conversation functionality that employs the public network 52 and data exchange functionality that employs the internet network 51, such as a portable telephone or a smartphone. The voice conversation functionality is an example of voice call processing of the present invention. Further, the data exchange functionality is an example of data transmission processing of the present invention.

As illustrated in FIG. 2, the communication terminal 20 includes the IVR selection option acquisition section 21, an input accepting section 22, the call information transmission section 23, and a phone-call controller 24 as functional sections related to the incoming call assistance system 10. The IVR selection option acquisition section 21, the input accepting section 22, the call information transmission section 23, and the phone-call controller 24 are an example of a processing section of the present invention.

The IVR selection option acquisition section 21 acquires, from the IVR selection option DB 36 managed by the incoming call assistance device 30, information for generating a response signal in response to the IVR 42 included in the telephone system 40 of the call center 400 designated by the user 200.

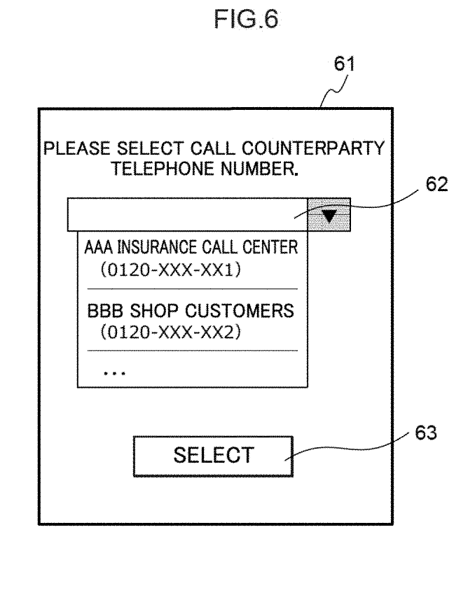

More specifically when an application provided by the incoming call assistance system 10 has started up in the communication terminal 20, the IVR selection option acquisition section 21 displays, for example, a call center designation screen 61 on a display device provided to the communication terminal 20, as illustrated in FIG. 6. In the example of FIG. 6, the call, center designation screen 61 includes a selection box 62 for using a pulldown menu to select the telephone number of the call center 400, this being the call-counterparty. Further, the call center designation screen 61 includes a selection button 63 that, when pressed, designates the call center 400 selected by the selection box 62 as the call center 400 targeted for acquisition of IVR selection option information.

When the selection button 63 of the call center designation screen 61 has been pressed, the IVR selection option acquisition section 21 transmits the telephone number of the call center 400 selected by the selection box 62 to the incoming call assistance device 30. The IVR selection option information of the designated call center 400 is accordingly transmitted from the IVR selection option transmission section 31 of the incoming call assistance device 30 as described above. When the IVR selection option acquisition section 21 receives IVR selection option information transmitted from the IVR selection option transmission section 31, the IVR selection option acquisition section 21 passes the received IVR selection option information to the input accepting section 22.

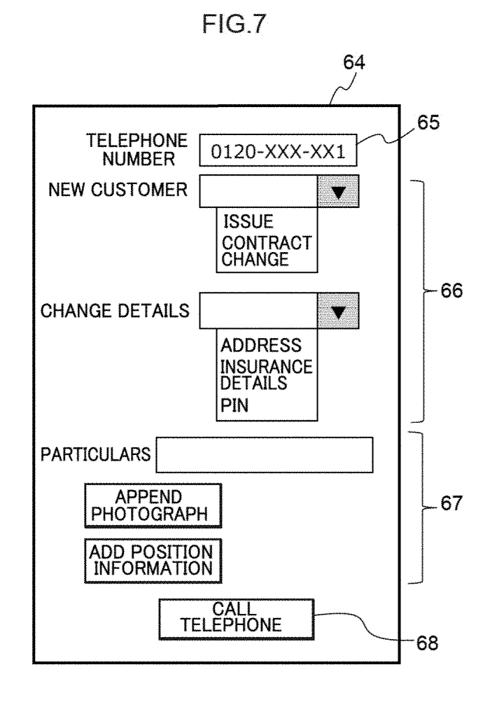

The input accepting section 22 displays, on the display device provided to the communication terminal 20, an input screen for accepting input of information for generating the response signal in response to the IVR 42 of the call center 400 based on the IVR selection option information passed from the IVR selection option acquisition section 21. FIG. 7 illustrates an example of an input screen 64. The example of FIG. 7 includes a telephone number display region 65 that displays the telephone number of the designated call center 400, and an IVR information input region 66 for inputting information for generating the response signal in response to the IVR 42.

In the IVR information input region 66, the input accepting section 22 displays items of each stage based on the IVR selection option information, and also displays selection boxes for selecting the selection option corresponding to each item. For example, the IVR selection option information illustrated in FIG. 4 is acquired corresponding to the telephone number “0120-XXX-XX1” of the call center 400. In this case, the input accepting section 22 extracts, as items of the highest stage, the IVR selection option information having only the telephone number of the call center 400 as the key, and displays the “item name” thereof in the IVR information input region 66. Further, corresponding to display of the item names, the input accepting section 22 disposes, in the IVR information input region 66, a selection box enabling selection of any “selection option name” of the selection options of the same stage. In cases in which an item of the next stage is present, the item name and selection boxes of the next stage are disposed in the IVR information input region 66 below the item names and the selection box of the highest stage.

Further, the input screen 64 includes an additional information input region 67 for inputting additional information other than the information for generating the response signal in response to the IVR 42. The input accepting section 22 disposes, for example, a textbox into which text data can be input and command buttons for, for example, appending photograph data or adding position information when pressed, in the additional information input region 67. For example, when the command button for appending the photograph data has been pressed, processing capable of appending photograph data by, for example, starting up camera functionality installed in the communication terminal 20 or reading photograph data stored in the communication terminal 20 is set to execute. Further, for example, when the command button for adding position information has been pressed, processing capable of adding position information by determining the current position of the communication terminal 20 using a global positioning system (GPS) receiver installed in the communication terminal 20 is set to execute.

Note that the additional information is not limited to text data, photograph data, and position information as described above. For example, other information such as voice audio or video footage may also be added. The information input to the IVR information input region 66 and the information input to the additional information input region 67 are examples of a message of the present invention. Further, the input screen 64 includes a phone-call button 68 that when pressed, calls the telephone number displayed on the telephone number display region 65 from the communication terminal 20 via the public network 52.

When the phone-call button 6$ of the input screen 64 is pressed, the call information transmission section 23 generates call information and transmits the generated call information to the incoming call assistance device 30. The telephone number displayed in the telephone number display region 65 (the telephone number of the call center 400), the telephone number of the communication terminal 20, and the information input to the IVR information input region 66 and the additional information input region 67 are incorporated into the call information. The call information transmission section 23 may, for example, convert the information input to the IVR information input region 66 into a response signal based on the IVR selection option information, and may incorporate the converted information into the call information as the IVR selection results.

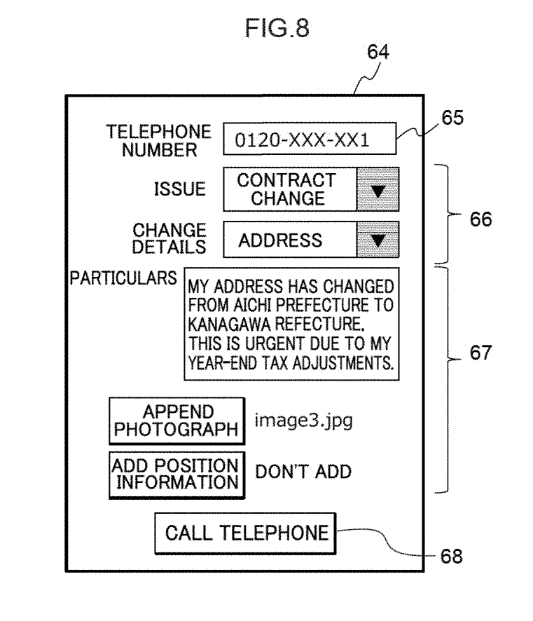

For example, suppose the telephone number of the communication terminal 20 is “090-XXXX-XX1” and input from the user 200 into the IVR information input region 66 and the additional information input region 67 has been accepted, as illustrated in FIG. 8. In such a case, for example, call information such as (0120-XXX-XX1, 090-XXXX-XXX1, #2#1, address . . . , image3.jpg,) may be generated. Note that the third element is the 1R selection result, and is the information input to the IVR information input region 66 of the input screen 64 converted into the response signal based on the IVR selection option information. Further, although the sixth element is position information, this is blank since the position information is not being added in the example of FIG. 8. In cases in which the position information is added, for example, position information representing the latitude and longitude is added. Note that the third piece of incoming call information of the incoming call information DB 37 illustrated in FIG. 5 is an example of information registered to the incoming call information DB 37 when the call information of the above example is acquired by the call information acquisition section 32 of the incoming call assistance device 30.

When the phone-call button 68 of the input screen 64 has been pressed, the phone-call controller 24 generates a call signal that the telephone number displayed in the telephone number display region 65 concatenated with the response signal indicating the IVR selection result. Further, the phone-call controller 24 calls the conversation functionality of the communication terminal 20 and controls such that the generated call signal is sent to the public network 52. Accordingly, a telephone call can be made from the communication terminal 20 to the call center 400, and the IVR 42 can be responded to without listening to the guidance of the IVR 42 of the call center 400.

Note that in cases in which the IVR 42 accepts a response signal indicating a selection option for stage each stage at the point at which playback of the guidance of the stage finishes, the phone-call controller 24 may control such that response signals for each stage are sent individually at a timing at which the guidance of the stage finishes. Since the timing at which the guidance of each stage finishes is defined in the IVR definitions 43, the timing can be extracted as information needed for generating the response signal, the timing can be registered in the IVR selection option DB 36, and the timing can be acquired as IVR selection option information.

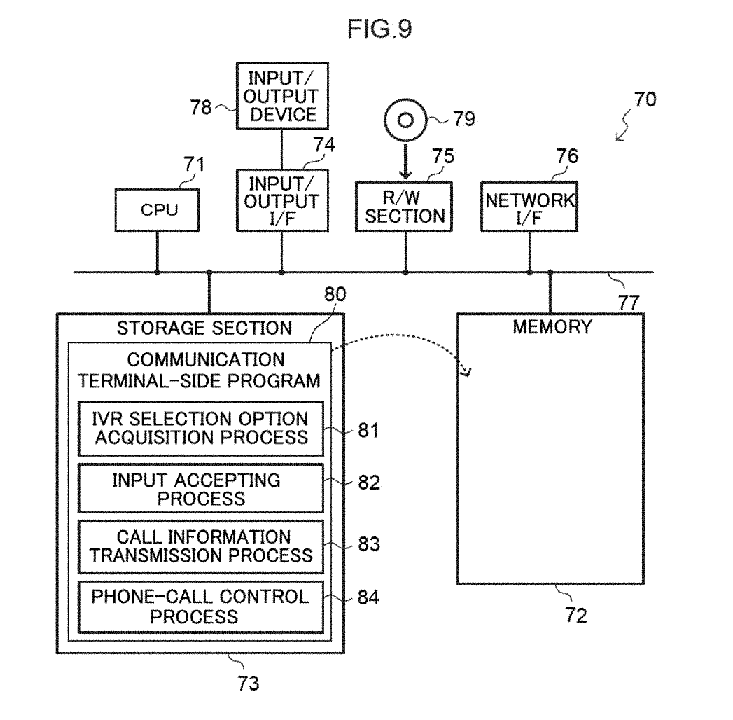

The communication terminal 20 may, for example, be implemented by a computer 70 illustrated in FIG. 9. The computer 70 includes a CPU 71, memory 72 serving as a temporary storage region, and a non-volatile storage section 73. Further, the computer 70 includes an input/output interface (I/F) 74 to which input/output devices 78, such as a display device and an input device, are connected. Further, the computer 70 includes a read/write (R/W) section 75 that controls reading and writing of data from and to a recording medium 79, and a network I/F that is connected to a network such as the internet. The CPU 71, the memory 72, the storage section 73, the input/output I/F 74, the IVR section 75, and the network I/F 76 are connected to one another via a bus 77.

The storage section 73 may, for example, be implemented by a hard disk drive (HDD), a solid state drive (SSD), flash memory, or the like. A communication terminal-side program 80 that causes the computer 70 to function as the communication terminal 20 is stored on the storage section 73, which serves as a storage medium. Although not illustrated in the drawings, programs, data, and the like related to other applications that run on the communication terminal 20 are also stored in the storage section 73.

The CPU 71 reads the communication terminal-side program 80 from the storage section 73, expands the communication terminal-side program 80 into the memory 72, and sequentially executes the processes included in the communication terminal-side program 80.

The communication terminal-side program 80 includes an IVR selection option acquisition process 81, an input accepting process 82, a call information transmission process 83, and a phone-call control process 84. The CPU 71 operates as the IVR selection option acquisition section 21 illustrated in FIG. 2 by executing the IVR selection option acquisition process 81. Further, the CPU 71 operates as the input accepting section 22 illustrated in FIG. 2 by executing the input accepting process 82. Further, the CPU 71 operates as the call information transmission section 23 illustrated in FIG. 2 by executing the call information transmission process 83. Further, the CPU 71 operates as the phone-call controller 24 illustrated in FIG. 2 by executing the phone-call control process 84. The computer 70, which executes the communication terminal-side program 80, thereby functions as the communication terminal 20.

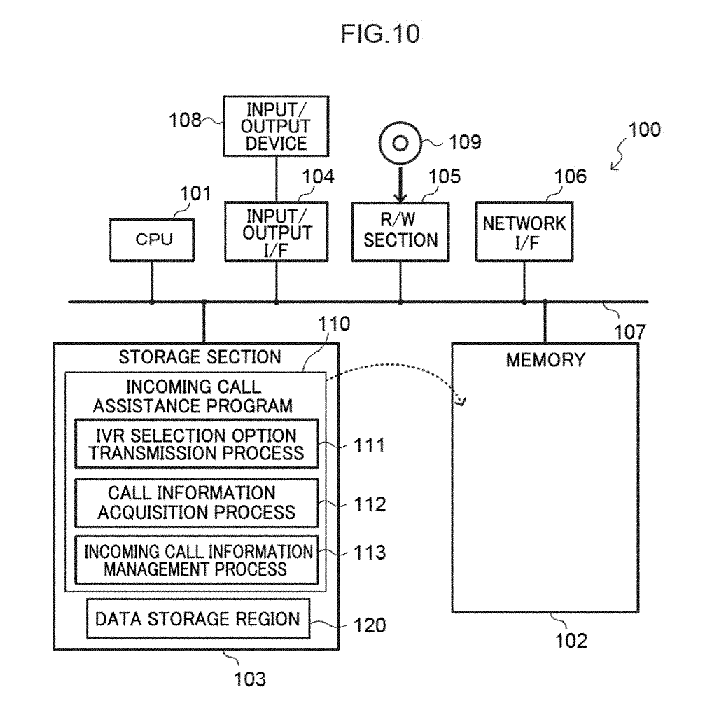

The incoming call assistance device 30 may for example, be implemented by a computer 100 illustrated in FIG. 10. The computer 100 includes a CPU 101, memory 102, and a storage section 103. Further, the computer 100 includes an input/output I/F 104 to which input/output devices 108 are connected, an R/W section 105 that controls reading and writing of data front and to a recording medium 109, and a network I/F 106. The CPU 101, the memory 102, the storage section 103, the input/output I/F 104, the R/W section 105, and the network I/F 106 are connected to one another via a bus 107.

The storage section 103 may, for example, be implemented by an HDD, an SSD, flash memory, or the like. An incoming call assistance program 110 that causes the computer 100 to function as the incoming call assistance device 30 is stored in the storage section 103, which, serves as a storage medium. Further, the storage section 103 includes a data storage region 120 that stores data included in the IVR selection option DB 36 and the incoming call information DB 37.

The CPU 101 reads the incoming call assistance program 110 from the storage section 103, expands the incoming call assistance program 110 into the memory 102, and sequentially executes the processes included in the incoming call assistance program 110. Further, the CPU 101 reads the data from the data storage region 120 and expands the IVR selection option DB 36 and the incoming call information DB 37 into the memory 102.

The incoming call assistance program 110 includes an IVR selection option transmission process 111, a call information acquisition process 112, and an incoming call information management process 113. The CPU 101 operates as the IVR selection option transmission section 31 illustrated in FIG. 2 by executing the IVR selection option transmission process 111. Further, the CPU 101 operates as the call information acquisition section 32 illustrated in FIG. 2 by executing the call information acquisition process 112. Further, the CPU 101 operates as the incoming call information management section 33 illustrated in FIG. 2 by executing the incoming call information management process 113. The computer 100, which executes the incoming call assistance program 110, thereby functions as the incoming call assistance device 30.

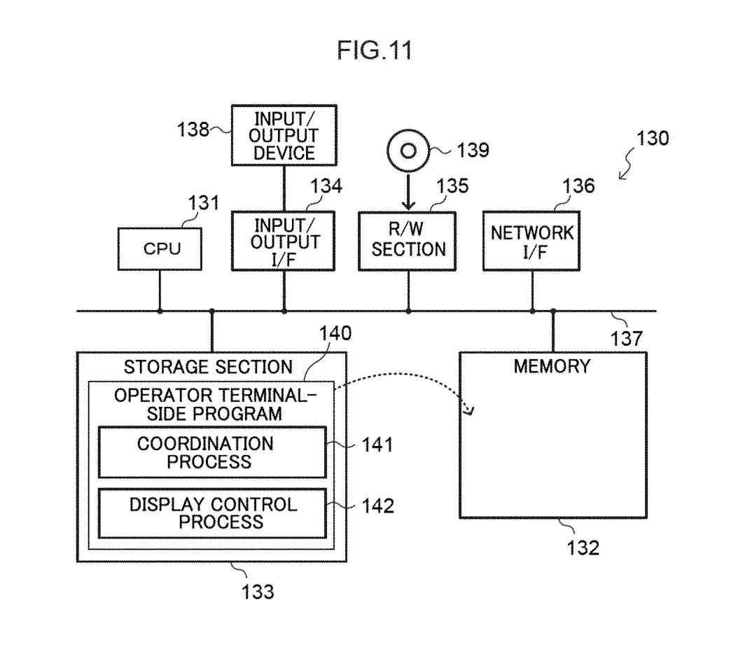

The operator terminal 46 may, for example, be implemented by a computer 130 illustrated in FIG. 11. The computer 130 includes a CPU 131, memory 132, and a storage section 133. Further, the computer 130 includes an input/output I/F 134 to which input/output devices 138 are connected, an R/W section 135 that controls reading and writing of data from and to a recording medium 139, and a network I/F 136. The CPU 131, the memory 132, the storage section 133, the input/output I/F 134, the R/W section 135, and the network I/F 136 are connected to one another via a bus 137.

The storage section 133 may be implemented by an HDD, an SSD, flash memory, or the like. An operator terminal-side program 140 that causes the computer 130 to function as the operator terminal 46 is stored in the storage section 133, which serves as a storage medium.

The CPU 131 reads the operator terminal-side program 140 from the storage section 133, expands the operator terminal-side program 140 into the memory 132, and sequentially executes the processes included in the operator terminal-side program 140.

The operator terminal-side program 140 includes a coordination process 141 and a display control process 142. The CPU 131 operates as the coordination section 47 illustrated in FIG. 2 by executing the coordination process 141. Further, the CPU 131 operates as the display controller 48 illustrated in FIG. 2 by executing the display control process 142. The computer 130, which executes the operator terminal-side program 140, thereby functions as the operator terminal 46.

Note that the functionalities respectively implemented by the communication terminal-side program 80, the incoming call assistance program 110, and the operator terminal-side program 140 may be implemented by, for example, a semiconductor integrated circuit, and more specifically, by an application specific integrated circuit (ASIC).

Next, operation of the incoming call assistance system 10 according to the present exemplary embodiment is described. First, the respective processing flows of the communication terminal-side program 80, the incoming call assistance program 110, and the operator terminal-side program 140 are described, followed by description of the flow of processing in the incoming call assistance system 10 overall.

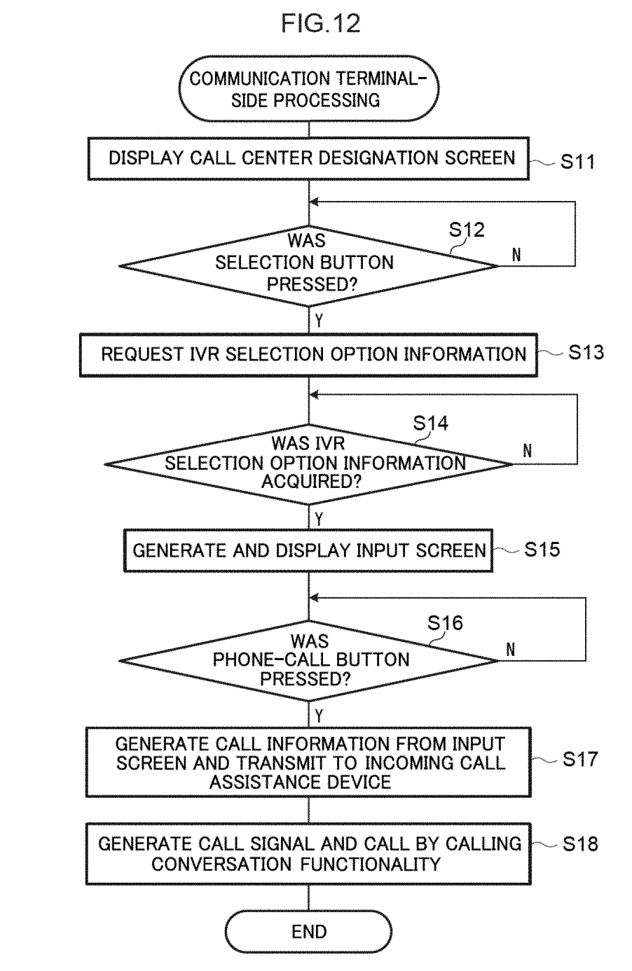

First, communication terminal-side processing performed by the CPU 71 executing the communication terminal-side program 80 is described, with reference to FIG. 12. The communication terminal-side processing is stalled in the communication terminal 20 by an application provided by the incoming call assistance system 10 being started up.

At step S11, the IVR selection option acquisition section 21 displays the call center designation screen 61 on the display device provided to the communication terminal 20. Next, at step S12, the IVR selection option acquisition section 21 determines whether or not the selection button 63 of the call center designation screen 61 has been pressed. Processing transitions to step S13 in cases in which the selection button 63 has been pressed, or the determination of the present step is repeated in cases in which the selection button 63 has not been pressed.

At step S13, the IVR selection option acquisition section 21 requests the IVR selection option information by transmitting, to the incoming call assistance device 30, the telephone number of the call center 400 selected by the selection box 62 when the selection button 63 of the call center designation screen 61 was pressed.

Next, at step S14, the IVR selection option acquisition section 21 determines whether or not the IVR selection option information was acquired from the incoming call assistance device 30. Processing transitions to step S15 in cases in which the IVR selection option information was acquired, or the determination of the present step is repeated in cases in which the IVR selection option information was not acquired.

At step S15, the IVR selection option acquisition section 21 passes the acquired IVR selection option information to the input accepting section 22. Then, based on the IVR selection option information, the input accepting section 22 generates the input screen 64 for accepting input of information for generating the response signal in response to the IVR 42, like that illustrated in FIG. 7 for example, and displays the generated input screen 64 on the display device provided to the communication terminal 20.

Next, at step S16, the call information transmission section 23 determines whether or not the phone-call button 68 of the input screen 64 has been pressed. Processing transitions to step 17 in cases in which the phone-call button 68 has been pressed, or the determination of the present step is repeated in cases in which the phone-call button 68 has not been pressed.

At step S17, the call information transmission section 23 generates call information including the telephone number of the call center 400 displayed in the telephone number display region 65, the telephone number of the communication terminal 20, and the information input to the IVR information input region 66 and the information input to the additional information input region 67. The call information transmission section 23 then transmits the generated call information to the incoming call assistance device 30.

Next, at step S18, the phone-call controller 24 generates the call signal, which is the telephone number of the call center 400 displayed in the telephone number display region 65 of the input screen 64 concatenated with the response signal indicating the IVR selection result. The phone-call controller 24 then calls the conversation functionality of the communication terminal 20 and controls so as make a phone-call to the call center 400 by sending the generated call signal to the public network 52. The communication terminal-side processing then ends.

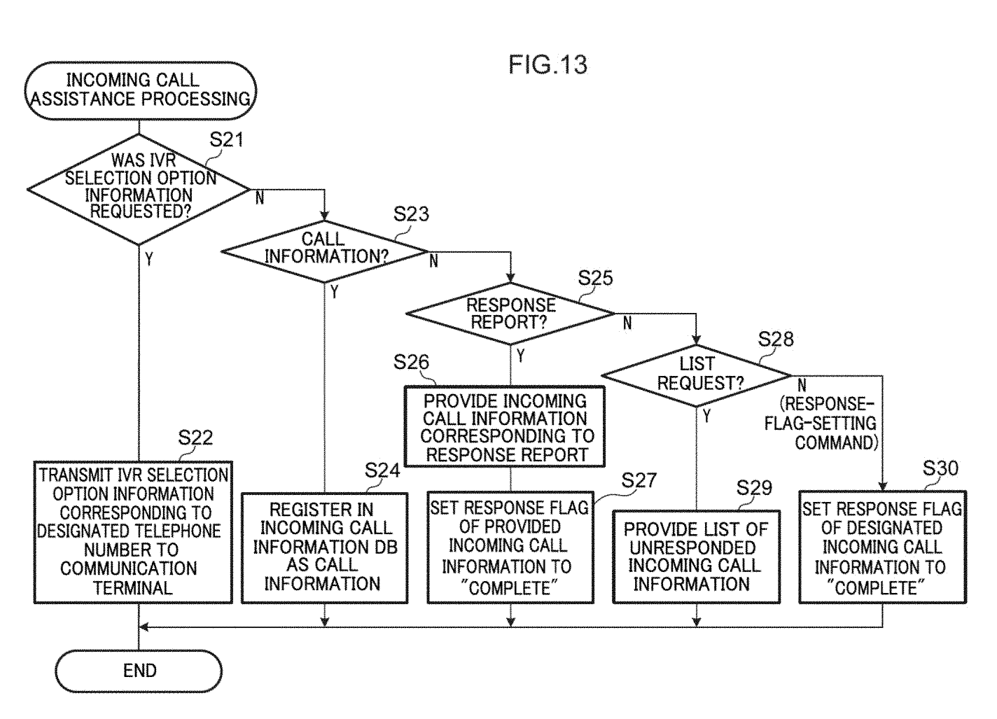

Next, incoming call assistance processing performed by the CPU 101 executing the incoming call assistance program 110 is described with reference to FIG. 13. The incoming call assistance processing is started by the reception of any data by the incoming call assistance device 30.

At step S21, the IVR selection option transmission section 31 determines whether or not the received data is a request, transmitted from the communication terminal 20, for the IVR selection option information designated by the telephone number of the call center 400. Processing transitions to step S22 in cases in which the received data is a request for IVR selection option information. At step S22, the IVR selection option transmission section 31 acquires, from the IVR selection option DB 36, the IVR selection option information corresponding to the telephone number of the designated call center 400, and transmits the acquired IVR selection option information to the communication terminal 20. The incoming call assistance processing then ends.

On the other hand, processing transitions to step S23 in cases in which the received data is not a request for IVR selection option information. At step S23, the call information acquisition section 32 determines whether or not the received data is call information transmitted from the communication terminal 20. Processing transitions to step S24 in cases in which the received data is call information. At step S24, the call information acquisition section 32 registers the acquired call information and the incoming call date and time in the incoming call, information DB 37 as incoming call information. The incoming call assistance processing then ends.

On the other hand, processing transitions to step S25 in cases in which the received data is not call information. At step S25, the incoming call information management section 33 determines whether or not the received data is a response report transmitted from the operator terminal 46. Processing transitions to step S26 in cases in which the received data is a response report. At step S26, the incoming call information management section 33 searches for corresponding incoming call information from the incoming call information DB 37 using the telephone number of the call center 400, the telephone number of the communication terminal 20, and the response date and time included in the response report as a key, and provides the found incoming call information to the coordination section 47. Next, at step S27, the incoming call information management section 33 sets the response flag of the incoming call information provided to the coordination section 47 to “complete” in accordance with the response report. The incoming call assistance processing then ends.

On the other hand, processing transitions to step S28 in cases in which the received data is not a response report. At step S28, the incoming call information management section 33 determines whether or not the received data is a list request, transmitted from the operator terminal 46, for unresponded incoming call information. Processing transitions to step S29 in cases in which the received data is a list request. At step S29, the incoming call information management section 33 searches for unresponded incoming call information from the incoming call information DB 37 using the information included in the list request as a query, converts the found incoming call information to a list, and provides the list to the coordination section 47. The incoming call assistance processing then ends.

On the other hand, in cases in which the received data is not a list request, the incoming call information management section 33 determines that the received data is a response-flag-setting command and processing transitions to step S30. At step S30, the incoming call information management section 33 sets the response flag of the incoming call information identified by information included in the response-flag-setting command, from out of the incoming call information included in the incoming call information DB 37, to “complete”, The incoming call assistance processing then ends.

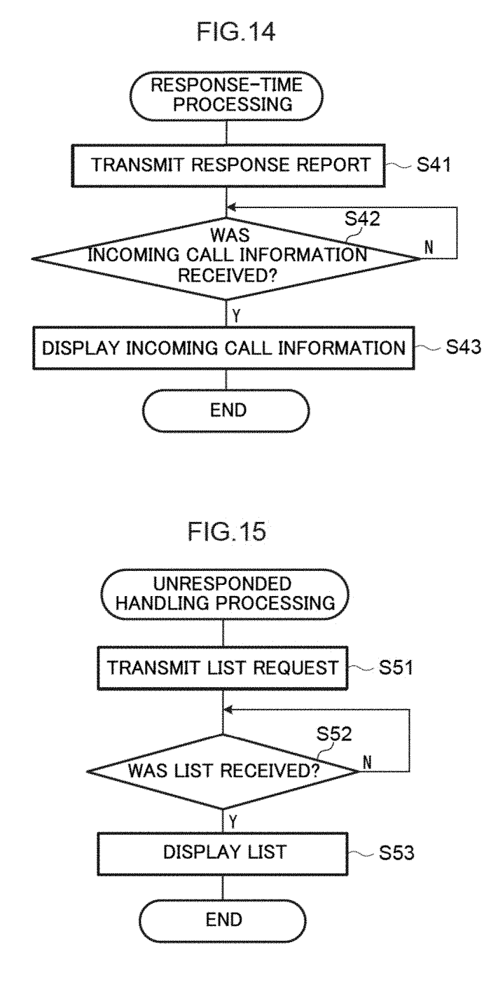

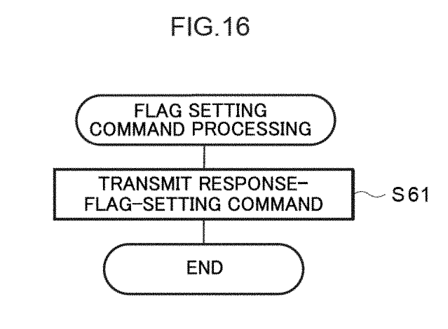

Next, operator terminal-side processing is described, which includes response-time processing, unresponded handling processing, and flag setting processing, performed by the CPU 131 executing the operator terminal-side prop am 140, with reference to FIG. 14 to FIG. 16. The response-time processing illustrated in FIG. 14 is executed when it is detected that the operator 450 has responded to an incoming call from the communication terminal 20 connected to the line of the telephone 45 of the corresponding operator terminal 46 (that the operator 450 picked up the telephone). Further, the unresponded handling processing illustrated in FIG. 15 is executed when the operator 450 operates the operator terminal 46 to request a list of unresponded incoming call information. Further, the flag setting command processing illustrated in FIG. 16 is executed when the operator 450 operates the operator terminal 46 to command that incoming call information be set as responded to.

At step S41 of the response-time processing illustrated in FIG. 14, the coordination section 47 transmits, to the incoming call assistance device 30, a response report including the telephone number of the call center 400 where the operator terminal 46 is disposed, the telephone number of the communication terminal 20, and the response date and time information.

Next, at step S42, the coordination section 47 determines whether or not incoming call information was received from the incoming call assistance device 30. Processing transitions to step S43 in cases in which incoming call information was received, or the determination of the present step is repeated in cases in which incoming call information was not received.

At step S43, the coordination section 47 passes the received incoming call information to the display controller 48. The display controller 48 then displays the incoming call information on the display device provided to the operator terminal 46 and the response-time processing ends.

At step S51 in the unresponded handling processing illustrated in FIG. 15, the coordination section 47 transmits to the incoming call assistance device 30 a list request including the telephone number of the call center 400 in which the operator terminal 46 is disposed. Further, designation information for designating the incoming call information to be incorporated in the list, such as designation of a date and time or an IVR selection result, may be included in the list request if needed.

Next, at step S52, the coordination section 47 determines whether or not a list of unresponded incoming call information was received from the incoming call assistance device 30. Processing transitions to step S53 in cases in which the list was received, or the determination of the present step is repeated in cases in which the list was not received.

At step S53, the coordination section 47 passes the list of received unresponded incoming call information to the display controller 48. The display controller 48 then displays the list of unresponded incoming call information on the display device provided to the operator terminal 46 and the unresponded handling processing ends.

In the flag setting command processing illustrated in FIG. 16, at step S61, the coordination section 47 transmits a response-flag-setting command to the incoming call assistance device 30. The coordination section 47 incorporates information identifying incoming call information into the response-flag-setting command, such as the telephone number of the call center 400 in which the operator terminal 46 is disposed, the caller's telephone number, and the incoming call date and time. The flag setting command processing then ends.

Note that incoming call information to make a follow-up telephone call to may be selected from the list of unresponded incoming call information, in order to perform coordination such that a call from the telephone 45 addressed to the caller's telephone number included in the incoming call information is made by the coordination section 47. In such cases, the coordination section 47 may transmit a response-flag-setting command that includes the incoming call information when triggered by a connection being detected between the line and the communication terminal 20 indicated by the caller's telephone number.

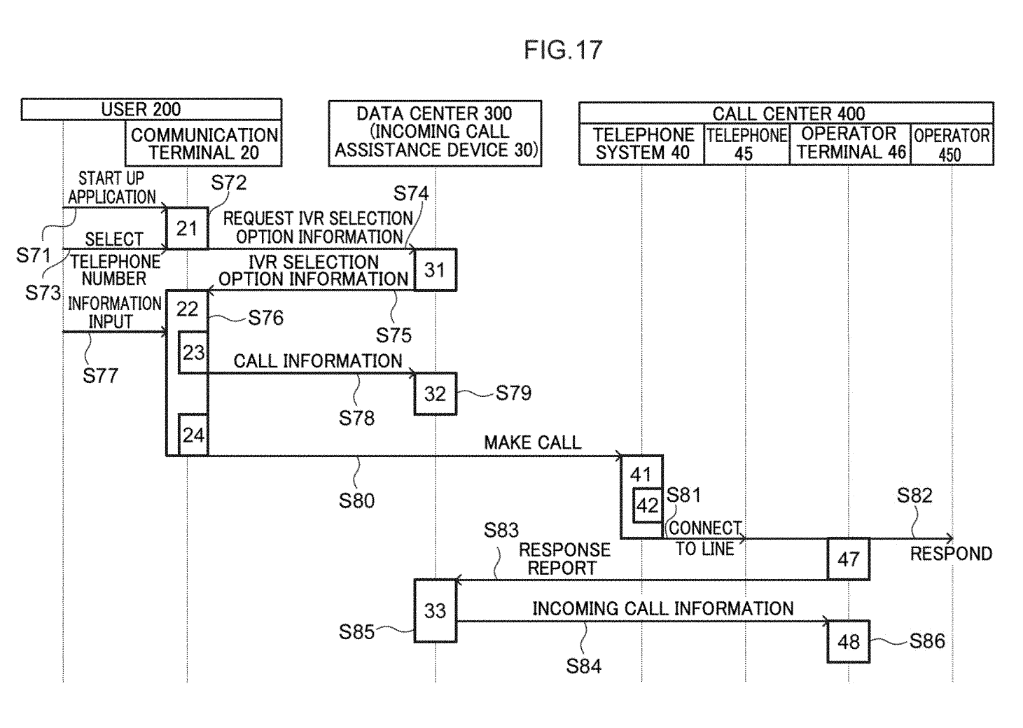

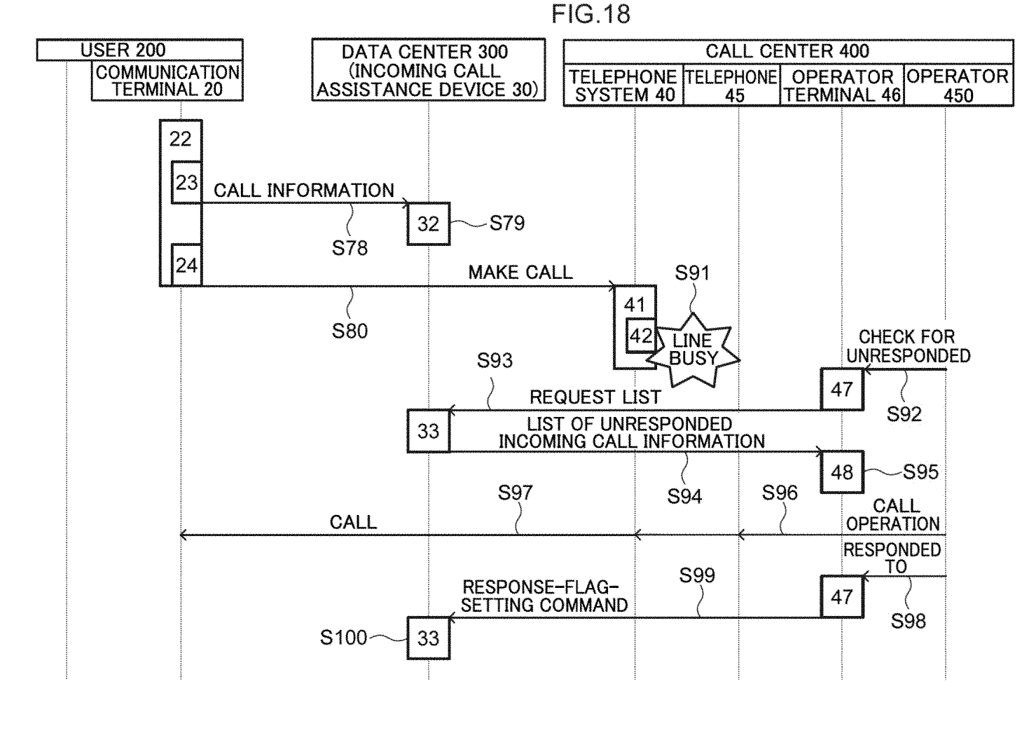

Next, a flow of processing of die incoming call assistance system 10 overall is described, including the exchange of information between the communication terminal 20, the incoming call assistance device 30, and the call center 400, with reference to the sequence charts of FIG. 17 and FIG. 18.

First, as illustrated in FIG. 17, the user 200 operates the communication terminal 20 and starts up the application provided by the incoming call assistance system 10 (S71). The IVR selection option acquisition section 21 then displays the call center designation screen 61 on die display device provided to the communication terminal 20 (S72). The user 200 selects the telephone number of the call center 400 to make a telephone call to from the selection box 62 and presses the selection button 63 (S73). When the selection button 63 is pressed, the IVR selection option acquisition section 21 requests the IVR selection option information by transmitting the telephone number of the call center 400 selected by the selection box 62 to the incoming call assistance device 30 (S74).

In the incoming call assistance device 30, when a request for IVR selection option information is received from the communication terminal 20, the IVR selection option transmission section 31 acquires the IVR selection option information corresponding to the telephone number of the designated call center 400 from the IVR selection option DB 36 and transmits the acquired IVR selection option information to the communication terminal 20 (S75).

In the communication terminal 20, when the IVR selection option information is received from the incoming call assistance device 30, the input accepting section 22 generates an input screen 64 for receiving input of information for generating a response signal in response to the IVR 42 based on the IVR selection option information. The input accepting section 22 then displays the input screen 64 on the display device provided to the communication terminal 20 (S76). The user 200 employs the IVR information input region 66 of the input screen 64 and the selection boxes, textboxes, command buttons, etc. of the additional information input region 67 to input information as needed, and presses the phone-call button 68 (S77).

When the phone-call button 68 is pressed by the user 200, the call information transmission section 23 generates call information and transmits the generated call information to the incoming call assistance device 30 (S78). The call information transmission section 23 incorporates, into the call information, the telephone number of the call center 400 displayed in the telephone number display region 65 of the input screen 64, the telephone number of the communication terminal 20, and the information input to the IVR information input region 66 and the additional information input region 67.

When the call information transmitted from the communication terminal 20 is received by the incoming call assistance device 30, the call information acquisition section 32 registers the acquired call information and the incoming call date and time as the incoming call information in the incoming call information DB 37 (S79).

Further, in the communication terminal 20, when the phone-call button 68 of the input screen 64 has been pressed by the user 200, the above call information is transmitted and phone-call processing is also executed. More specifically, the phone-call controller 24 generates a call signal that is the telephone number of the call center 400 displayed in the telephone number display region 65 of the input screen 64 concatenated with the response signal indicating the IVR selection result. The phone-call controller 24 then calls conversation functionality of the communication terminal 20 and performs control such that a phone-call is made to the call center 400 by sending the generated call signal to the public network 52 (S80).

When the call signal from the communication terminal 20 is received by the telephone system 40 of the call center 400 as an incoming call, the exchange 41 and the IVR 42 coordinate and the incoming call from the communication terminal 20 is connected to the line of the telephone 45 of the responsible operator 450 (S81).

When detected that the operator 450 has responded to the incoming call (has picked up the telephone) (S82), the coordination section 47 transmits a response report to the incoming call assistance device 30 (S83). The coordination section 47 incorporates the following information into the response report: the telephone number of the call center 400 in which the operator terminal 46 is disposed, the caller's telephone number obtained from the incoming call responded to, and the response date and time.

The response report transmitted from the operator terminal 46 is received in the incoming call assistance device 30. The incoming call information management section 33 searches for corresponding incoming call information from the incoming call information DB 37 using the telephone number of the call center 400, the caller's telephone number, and the response date and time included in the response report as a key, and provides the found incoming call information to the coordination section 47 (S84). Further, the incoming call information management section 33 sets the response flag of the incoming call information provided to the coordination section 47 in accordance with the response report to “complete” (S85).

In the operator terminal 46, when incoming call information transmitted from the incoming call assistance device 30 is received, the display controller 48 displays the incoming call information on the display device provided to the operator terminal 46 (S86). Additional information is included in the incoming call information in addition to the IVR selection result, and this information is referenced when the operator 450 listens to the user 200.

On the other hand, as illustrated in FIG. 18, the line that the incoming call from the communication terminal 20 preferably connects to is busy in some cases (S91). Even in such cases, the call information transmitted from the communication terminal 20 is registered in the incoming call information DB 37 of the incoming call assistance device 30 as incoming call information (S79).

Then, when the operator 450 operates the operator terminal 46 at a predetermined timing to request a list of unresponded incoming call information (S92), the coordination section 47 transmits a list request to the incoming call assistance device 30 requesting a list of unresponded incoming call information (S93). The coordination section 47 incorporates the telephone number of the call center 400 in which the operator terminal 46 is disposed into the list request, and also incorporates designation information for designating the incoming call information to be incorporated into the list, such as a designation of a date and time or an IVR selection result, if needed.

In the incoming call assistance device 30, when a list request transmitted from the operator terminal 46 is received, the incoming call information management section 33 searches for unresponded incoming call information from the incoming call information DB 37, using the information included in the list request as a query. The incoming call information management section 33 then converts the found incoming call information to a list and provides the list to the coordination section 47 (S94).

In the operator terminal 46, when the list of unresponded incoming call information transmitted from the incoming call assistance device 30 has been received, the display controller 48 displays the list of unresponded incoming call information on the display device provided to the operator terminal 46 (S95). The operator 450 can ascertain that an incoming call from the user 200 was missed or abandoned from the list of unresponded incoming call information, and a follow-up telephone call from the operator 450 to the user 200 can be made (S96, S97).

In cases in which incoming call information selected from the list has been followed up, the operator 450 operates the operator terminal 46 to command that the incoming call information be set as responded to (S98).

In the operator terminal 46, the coordination section 47 transmits, to the incoming call assistance device 30, a response-flag-setting command including information for identifying the incoming call information, such as the telephone number of the call center 400 in which the operator terminal 46 is disposed, the caller's telephone number, and the incoming call date and time (S99).

In the incoming call assistance device 30, when the response-flag-setting command transmitted from the operator terminal 46 is received, the incoming call information management section 33 identifies the target incoming call information from the incoming call information included in the incoming call information DB 37 based on the information included in the response-flag-setting command. The incoming call information management section 33 then sets the response flag of the identified incoming call information to “complete” (S100).

As described above, according to the incoming call assistance system of the present exemplary embodiment, when a call (voice call) is made from a communication terminal to the call center via the public network, in the communication terminal, the call is made to the call center, and information related to the call is transmitted to the incoming call assistance device. In the incoming call assistance device, information related to a call transmitted from the communication terminal is acquired and incoming call information for the call center is registered in a database as call information. Identifying information for the communication terminal and identifying information for the call center may be incorporated into the information related to the call. It can accordingly be ascertained at the call center-side that the incoming call was missed or abandoned based on the incoming call information registered in the database. Namely, incoming call history can be left even when there is a shortage of lines. This enables measures to be taken, such as a follow-up telephone call to be made to the user from the operator of the call center.

Further, the identifying information of the communication terminal, which is the source of the telephone call, can be the telephone number of the communication terminal. The telephone number of the communication terminal can be acquired in the call center as the callers telephone number using a caller's number report service, and can therefore be simply employed as a key when searching through incoming call information registered in the database.

Further, information for generating the response signal in response to the IVR of the call center can be incorporated into the information related to the call. Furthermore, when making a phone-call from the communication terminal to the call center, the call signal can be incorporated into a response signal for the IVR in advance by acquiring this information before making the phone-call from the communication terminal to the call center. This enables the user to avoid, for example, listening to long guidance from the IVR and making mistaken button presses when sending the response signal.

Further, various information such as information for generating the response signal in response to the IVR of the call center, text data, photograph data, or position information can be incorporated into the information related to the call, and this information can be registered as incoming call information. The operator terminal of the call center accordingly references the incoming call information, which gives assistance when listening to the user.

Note that although a case in which the identifying information of the communication terminal is the telephone number of the communication terminal has been described in the exemplary embodiment above, there is no limitation thereto. For example, the MAC address of the communication terminal, a member number of the user, or the like may be employed. In such cases, the MAC address., member number, or the like may he acquired as the information for generating the response signal in response to the IVR, and may be incorporated into the call signal when a making a phone-call from the communication terminal to the call center. This enables the information obtained from the incoming call to the call center to be linked to the incoming call information registered in the database.

Further, although the telephone number was employed as an example of identifying information of the call center in the exemplary embodiment above, there is no limitation thereto. The company name, an identifier for identifying the company, a URL that the call center possesses for other uses, or the like may be employed, and may be the information serving as the key when the database in which incoming call information is registered is searched from the operator terminal.

Further, although a case in which the call destination that a telephone call is made to from the communication terminal is a telephone of the call center was described in the exemplary embodiment above, there is no limitation thereto. Further, the present invention is also applicable to general telephones without going via a system such as an IVR.

Although various means of contact are currently widespread, making enquiries to a call center by voice conversation is still a mainstream method for making enquiries. However, since the number of telephone lines in a call center is limited, there are also situations where an incoming call from a user is not successfully connected to the telephone of an operator for reasons such as a shortage of telephone lines that correspond to operators according with the stipulations of the user. In such situations, incoming call history from the user is not left in the call center in some cases.

Even in the related technology that assists callbacks and information exchange, incoming calls from a user are not successfully ascertained in some cases, such as when there is a shortage of lines.

One aspect has an advantageous effect of enabling incoming call history to be left even when there is a shortage of lines.

Note that in the mode described above, the communication terminal-side program 80, the incoming call assistance program 110, and the operator terminal-side program 140 are pre-stored (installed) on the storage sections 73, 103, and 133 respectively: however, there is no limitation thereto. The prom⁻am according to technology disclosed herein could also be provided in a mode recorded to a recording medium such as a CD-ROM, a DVD-ROM, or USB memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

10 incoming, call assistance system

20 communication terminal

21 IVR selection option acquisition section

22 input accepting section

23 call information transmission section

24 phone-call controller

30 incoming call assistance device

31 IVR selection option transmission section

32 call information acquisition section

33 incoming call information management section

36 selection option DB

37 incoming call information DB

40 telephone system

41 exchange

42 IVR

43 IVR definitions

45 telephone

46 operator terminal

47 coordination section

48 display controller

51 internet network

52 public network

61 call center designation screen

64 input screen

65 telephone number display region

66 IVR information input region

67 additional information input region

68 phone-call button

70, 100, 130 computer

71, 101, 131 CPU

72, 102, 132 memory

73, 103, 137 storage section

80 communication terminal-side program

110 incoming call assistance program

140 operator terminal-side program

200 user

300 data center

400 call center

450 operator

What is claimed is:

1. A communication terminal capable of making a voice call to a call destination designated in accordance with a call instruction, the communication terminal comprising:
a memory; and
a processor coupled to the memory and the processor configured to:
in response to the call instruction being detected, perform voice call processing with respect to the call destination and perform data transmission processing that transmits identifying information to an address associated with the call destination.

2. The communication terminal of claim 1, wherein the identifying information is communication terminal identifying information or user identifying information.

3. The communication terminal of claim 2, wherein the communication terminal identifying information or the user identifying information is a line number of the communication terminal,

4. The communication terminal of claim 1, wherein the data transmission processing includes, prior to the call instruction, transmitting a message that has been input in association with the call destination.

5. The communication terminal of claim 4, wherein, in cases in which the call destination receives a voice call from the communication terminal via an exchange that coordinates with an interactive voice response device, the message includes information for responding to the interactive voice response device.

6. The communication terminal of claim 4, wherein the message includes at least one of text data, image data, voice data, or position information of the communication terminal.

7. A non-transitory recording medium storing an incoming call assistance prop⁻am that is executable by a computer to perform a process at a communication terminal capable of making a voice call to a call destination designated in accordance with a call instruction, the process comprising:
in response to the call instruction being detected, performing voice call processing with respect to the call destination and performing data transmission processing that transmits identifying information to an address associated with the call destination.

8. The non-transitory recording medium of claim 7, wherein the identifying information is communication terminal identifying information or user identifying information.

9. The non-transitory recording medium of claim 8, wherein the communication terminal identifying information or the user identifying information is a line number of the communication terminal.

10. The non-transitory recording medium of claim 7, wherein the data transmission processing includes, prior to the call instruction, transmitting a message that has been input in association with the call destination.

11. The non-transitory recording medium of claim 10, wherein, in cases in which the call destination receives a voice call from the communication terminal via an exchange that coordinates with an interactive voice response device, the message includes information for responding to the interactive voice response device.

12. The non-transitory recording medium of claim 10, wherein the message includes at least one of text data, image data, voice data, or position information of the communication terminal.

13. An incoming call assistance method, comprising causing a computer to execute a process in a communication terminal capable of making a voice call to a call destination designated in accordance with a call instruction, the process comprising:
by a processor, in response to the call instruction being detected, performing voice call processing with respect to the call destination and performing data transmission processing that transmits identifying information to an address associated with the call destination.

14. The incoming call assistance method of claim 13, wherein the identifying information is communication terminal identifying information or user identifying information.

15. The incoming call assistance method of claim 14, wherein the communication terminal identifying information or the user identifying information is a line number of the communication terminal.

16. The incoming call assistance method of claim 13, wherein the data transmission processing includes, prior to the call instruction, transmitting a message that has been input in association with the call destination.

17. The incoming call assistance method of claim 16, wherein, in cases in which the call destination receives a voice call from the communication terminal via an exchange that coordinates with an interactive voice response device, the message includes information for responding to the interactive voice response device.

18. The incoming call assistance method of claim 16, wherein the message includes at least one of text data, image data, voice data, or position information of the communication terminal.

19. An incoming call assistance device, comprising:
a memory; and
a processor coupled to the memory and the processor configured to:
in a communication terminal capable of making a voice call to a call destination designated in accordance with a call instruction, perform voice call processing with respect to the call destination and acquire identifying information transmitted by data transmission processing that transmits the identifying information to an address associated with the call destination; and
manage associations between the acquired identifying, information and identifying information of the call destination.

20. The incoming call assistance device of claim 19, wherein he call destination identifying information is a line number of the call destination.
